(19) United States
(12) Patent Application Publication
(10) Pub. No.: US 2011/0272940 A1
(43) Pub. Date: Nov. 10, 2011

(54) CONNECTOR FOR SPOOLABLE MEDIA

(76) Inventor: David Shand, Aberdeen (GB)

(21) Appl. No.: 13/001,109

(22) PCT Filed: Jun. 24, 2009
(86) PCT No.: PCT/GB2009/001581

§ 371 Date: Mar. 7, 2011

(30) Foreign Application Priority Data
Jun. 25, 2008 (GB) 0811638.6

(51) Int. Cl. E21B 17/046; F16L 21/00; F16L 25/00

(52) U.S. Cl. 285/331

(57) ABSTRACT

A connector (30) is provided for receiving a free end of a suspended portion of coiled tubing (27) and a free end of an additional portion of coiled tubing to be coupled to the suspended portion. The connector (30) includes first and second gripping means for gripping said respective free ends of the coiled tubing portions, and coupling means (60, 62) for coupling said first and second gripping means together, wherein the connector is dimensioned such that, when made up, it can pass through bores suitable for receiving the spoolable medium.

### FIELD OF THE INVENTION

The present invention relates to a connector for joining ends of a spoolable medium and particularly, but not exclusively, to a connector for joining ends of spoolable coiled tubing. The invention is particularly suitable for joining the ends of coiled tubing when the coiled tubing is used as a riser, or within a riser system.

### BACKGROUND TO THE INVENTION

Risers are well known in the oil industry and are used to couple a wellhead to a platform work surface. When the platform is floating vertical movement is compensated by well-known compensation mechanisms so that stresses due to ocean movement do not cause the riser to break or otherwise become damaged or compromised. Risers can be very large, heavy and expensive and can have diameters of the order of 36 inches. In the applicant's WO 2009/016346, there is disclosed a novel coiled tubing riser system which obviates and mitigates various problems with traditional risers.

In order to be able to use the riser offshore in depths greater than the length of one roll of coiled tubing, the coiled tubing must be joined in the system, and the length of coiled tubing which is already being installed as part of the riser must be suspended. When the riser is suspended using a riser hanger, as disclosed in applicant's co-pending UK application no. GB 0811640.2, the ends of the riser must be joined so that after the join is made the joined coiled tubing forms a longer riser suitable for use in deeper water.

### SUMMARY OF THE INVENTION

According to an aspect of the present invention there is provided a connector for receiving a free end of a suspended portion of coiled tubing and a free end of an additional portion of coiled tubing to be coupled to the suspended portion, the connector including first and second gripping means for gripping said respective free ends of the coiled tubing portions, and coupling means for coupling said first and second gripping means together, wherein the connector is dimensioned such that, when made up, it can pass through bores suitable for receiving the spoolable medium.

The connector may define a low profile connector. The connector may be dimensioned to extend through a support arrangement which in use supports the suspended portion of coiled tubing.

The connector may comprise a first connector portion which is adapted to be secured to the free end of the suspended coiled tubing and a second connector portion which is adapted to be secured to the free end of the additional portion of coiled tubing. The first and second connector portions may comprise the respective first and second gripping means of the connector to allow said portions to be firmly secured to the respective coiled tubing ends.

The free ends of the first and second connector portions may define an interengaging coupling arrangement. The first connector portion may define a female portion for receiving a complementary male portion on the second connector portion. The interengaging coupling arrangement may comprise collets and spring fingers which allow the connection to be releasable for withdrawing the riser after use. The free ends of the connector portions may comprise metal. The connection may comprise a sealing arrangement. The sealing arrangement may comprise a metal-to-metal sealing arrangement. The sealing arrangement may comprise a non-metal sealing arrangement, such as an elastomeric sealing arrangement.

Each connector portion may include a portion to be fitted over the free of a respective coiled tubing portion, and a moveable gripping portion, the moveable gripping portion being engaged by axial movement or rotation or the like to become wedged to the coil tubing portion so that each connector portion firmly grips the free end of the coil tubing. The gripping portion may be provided by slips. The slips may be actuated by a threaded collar to compress the slips against the outer surface of the coiled tubing.

Alternatively, the slips may be integral with the connector and rotation of the connector may have the effect of compressing the slip against the coiled tubing.

According to another aspect of the present invention there is provided a connector for connecting together first and second portions of coiled tubing, the connector comprising first and second connector portions each having a griping arrangement for gripping respective free ends of the first and second portions of coiled tubing, wherein the first and second connector portions have interengaging coupling components for coupling said first and second connector portions together.

According to a further aspect of the present invention there is provided a connector for receiving a free end of a suspended portion of coil tubing and a free end of a portion of coil tubing to be added to the suspended portion, the connector including first and second gripping means for gripping said respective free ends of the coil tubing portion, and coupling means for coupling said first and second gripping means together, the connector being dimensioned the proportioned such that, when made up, it can pass through bores suitable for receiving the spoolable medium.

The connector may have a first gripping portion which is secured to the free end of the suspended coil tubing in a coil tubing hanger and a second gripping portion which is secured to the free end of an additional portion of coil tubing hanger to be connected to the suspended portion, each of the first and second portions having respective actuatable gripping means to allow said portions to be firmly secured to the respective coil tubing ends.

The free end of the first connector portion may have a female portion for receiving a complementary male portion on the free end of the additional coil tubing connector. The free ends of the connection may be metal and when joined together form a metal-to-metal seal. The metal-to-metal seal may be provided by collets and spring fingers which allow the connection to be releasable for withdrawing the riser after use. Alternatively, the metal-to-metal seal may be replaced by a combination of a metal-to-metal seal and/or an elastomeric seal provided by suitable elastomers such as O-rings or the like.

Each connector portion may include a portion to be fitted over the free end of the coil tubing end and a moveable gripping portion, the moveable gripping portion being engaged by axial movement or rotation or the like to become wedged to the coil tubing portion so that the connected portion firmly grips the free end of the coil tubing. The gripping portion may be provided by slips and the slips may be actuated by a threaded collar to compress the slips against the outer surface of the coil tubing.

Alternatively, the slips may be integral with the connector and rotation of the connector has the effect of compressing the slip against the coil tubing.

According to another aspect of the present invention there is provided a method of connecting a first portion of coiled tubing to a second portion of coiled tubing, comprising using a connector according to any preceding aspect.

### BRIEF DESCRIPTION OF THE DRAWINGS

These and other aspects of the present invention will now be described, by way of example only, with reference to the accompanying drawings, in which:

FIG. 1 is a schematic diagram of a coil tubing riser system used with a vessel and incorporating a coil tubing hanger and a window for receiving a coil tubing connector in accordance with an embodiment of the invention, and

FIG. 2 is an enlarged longitudinal sectional view of a coil tubing connector in accordance with an embodiment of the invention joined free ends of the tubing shown in FIG. 1.

### DETAILED DESCRIPTION OF THE DRAWINGS

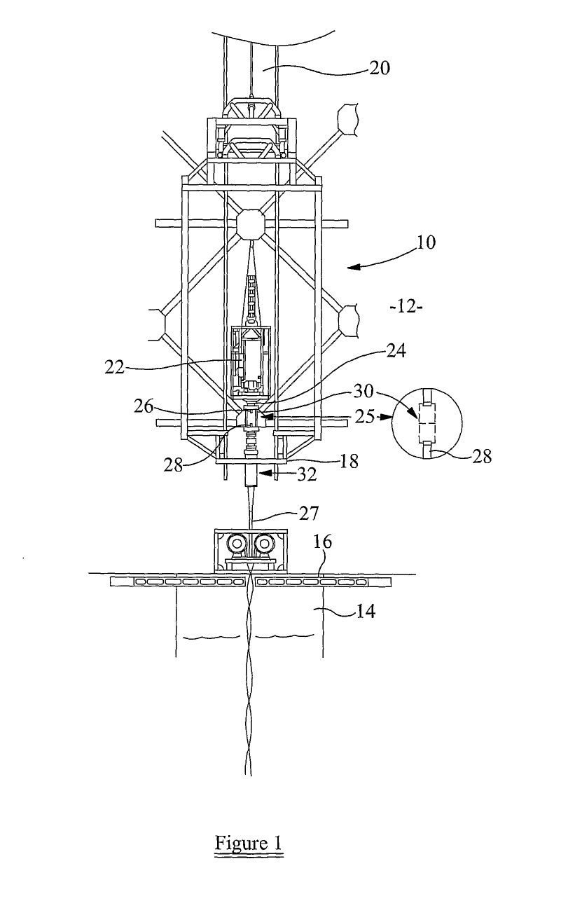

Reference is first made to FIG. 1 of the drawings which depicts part of a coil tubing riser system, generally indicated by reference numeral 10, used in a floating vessel 12 with a moon pool 14 beneath a moveable vessel floor 16. The entire coil tubing riser system is not described but it includes a compensated frame 18 which is coupled via a cable 20 to a compensator winch (not shown) for compensating for vessel movement. The complete coil tubing riser system is disclosed in more detail in applicant's WO 2009/016346, the disclosure of which is not essential to the understanding of this invention.

The compensated frame 18 supports a coil tubing injector head 22 which is coupled by a connector 24 to a coil tubing make-up window 25 which depicts the free ends 26,28 of the coil tubing 27 to be connected by a coil tubing connector 30, shown in broken outline, to allow longer tubing risers to be made up for use in deep water, i.e. water of such a depth that a single spool of coil tubing cannot operate as a riser and requires to be joined to another length of coil tubing. The free end 28 of coil tubing 27 is suspended in a coil tubing hanger 32 which is coupled to the compensated frame 18. The coil tubing hanger 32 is the subject of applicant's co-pending separate UK patent application no. GB 0811640.2 and the disclosure of which is not essential to the understanding of this invention.

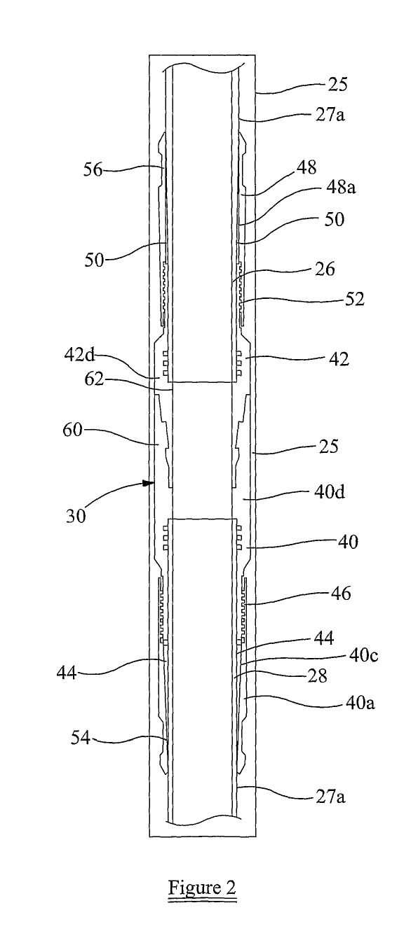

Reference is now made to FIG. 2 of the drawings which depicts the connector 30 assembled and coupled to the free ends 28,27 of the suspended coil tubing the additional coil tubing respectively. The connector 30 has two main portions which are shown joined together; a lower connected portion generally indicated by reference numeral 40, and an upper connected portion generally indicated by reference numeral 42. The two portions are almost identical and the lower portion 40 will be described first.

The lower connected portion 40 has a first collar 40a which is fed over the free end of coil tubing 28 by an operator gaining access via the window 25. Slips 44 are then positioned by the operator between the inner surface 40c of the collar 40a and the outer surface 27a of the coil tubing 27. A lower female connector 40d is then screwed onto the collar 40a using threaded portions 46 so that the connector 40d is threadedly engaged with the collar 40a. The slips 44 are compressed and thus engage the outer surface 27a of the coil tubing, thereby securing the lower portion 40 to the free end 28 of the coil tubing.

In the same way the upper connected portion 42 is assembled to the free end of the coil tubing portion 26. In this case, the upper connected portion has a first collar 48 which is inserted over the free end and then slips 50 are located between the outer surface of the coil tubing 27a and the inner surface 48a of the first collar 48. An upper male connector 42d is threadedly engaged with the first collar 48 via threaded portions 52 and the male connector 42d is screwed against collar 48, the slips 50 are compressed in the same way as slips 44 so that the upper connecting portion 42 firmly grips the free end of the upper coil tubing.

The lower connected portion 40 terminates in a female coupling arrangement 60, and the upper connected portion 42 terminates in a male coupling portion 62, such that when the male arrangement 62 is brought into connection with the female arrangement 60 under the weight of an axial stabbing force generated for example by the injector head 22, the connection is formed, as shown in FIG. 2, to create a metal-to-metal seal.

Each of the collars 40a and 48 has a fishing neck 54,56 respectively to facilitate gripping of the connector and fishing of the riser with connector attached should this be required. The diameter of the assembled connector is such that the connector can pass through a 5⅛″ (130.2 mm) bore such as is present in the tubing hanger 32.

Thus, in this way the connector permits the coil tubing riser to be extended and suitable for use in deepwater locations.

Various modifications may be made to the connector hereinbefore described without departing from the scope of the invention. For example, although a metal-to-metal seal is shown between the upper and lower connectors in the overall connector, it will be appreciated that this metal-to-metal seal may be replaced by a combination of a metal-to-metal seal and an elastomeric seal such as an O-ring, depending on the particular environmental conditions. A metal-to-metal seal is preferred in a corrosive fluid environment. The slips may be integral with a lower connector portion instead of being separate. The operation would be almost identical with the upper connector portion threadedly engaging with the lower portion to compress the slips on the outer surface of the coil tubing. The stabbing connection may be releasable and the engagement may include a collet with a plurality of spring-loaded fingers which may be engaged or disengaged by stabbing and/or rotation by techniques well known in the art. It will also be understood that the lower connector shown is a female connector and the upper as a male connector and it will be appreciated that the male and female parts can be reversed so that the operator is not constrained in his selection of deploying these parts, although it will be appreciated that it is easier to stab the male connector into the female connector and it is easier to align the ends in this way.

It will also be appreciated that the first ends of the connectors are provided with fishing neck which allow and facilitate of the connector and/or riser should this be required.

It will also be appreciated that this connector provides various advantages in that it provides a reliable and verifiable performance and also a good visual indication of the correct assembly. It is a relatively simple assembly process which facilitates verification and testing.

1. A connector for receiving a free end of a suspended portion of coiled tubing and a free end of an additional portion of coiled tubing to be coupled to the suspended portion, the connector including first and second gripping means for gripping said respective free ends of the coiled tubing portions, and coupling means for coupling said first and second gripping means together, wherein the connector is dimensioned such that, when made up, it can pass through bores suitable for receiving the spoolable medium.

2. The connector according to claim 1, dimensioned to extend through a support arrangement which in use supports the suspended portion of coiled tubing.

3. The connector according to claim comprising a first connector portion which is adapted to be secured to the free end of the suspended coiled tubing and a second connector portion which is adapted to be secured to the free end of the additional portion of coiled tubing.

4. The connector according to claim 3, wherein the first and second connector portions comprise the respective first and second gripping means of the connector to allow said portions to be firmly secured to the respective coiled tubing ends.

5. The connector according to claim 3, wherein the free ends of the first and second connector portions define an interengaging coupling arrangement.

6. The connector according to claim 5, wherein the interengaging coupling arrangement is releasable.

7. The connector according to claim 5, wherein the interengaging coupling arrangement comprises collets and spring fingers.

8. The connector according to claim 3, wherein the first connector portion defines a female portion for receiving a complementary male portion on the second connector portion.

9. The connector according to claim 3, wherein the free ends of the connector portions comprise metal.

10. The connector according to claim 3, further comprising a sealing arrangement configured to provide a seal between the first and second connector portions, when engaged.

11. The connector according to claim 10, wherein the sealing arrangement comprises a metal-to-metal sealing arrangement.

12. The connector according to claim 10, wherein the sealing arrangement comprises a non-metal sealing arrangement.

13. The connector according to claim 3, wherein each connector portion includes a portion to be fitted over the free end of a respective coiled tubing portion, and a moveable gripping portion, the moveable gripping portion being engaged by axial movement or rotation or the like to become wedged to the coil tubing portion so that each connector portion firmly grips the free end of the coil tubing.

14. The connector according to claim 13, wherein the gripping portion is provided by slips.

15. The connector according to claim 14, wherein the slips are actuated by a threaded collar to compress the slips against the outer surface of the coiled tubing.

16. The connector according to claim 14, wherein the slips are integral with the connector and rotation of the connector may have the effect of compressing the slip against the coiled tubing.

17. A connector for connecting together first and second portions of coiled tubing, the connector comprising first and second connector portions each having a griping arrangement for gripping respective free ends of the first and second portions of coiled tubing, wherein the first and second connector portions have interengaging coupling components for coupling said first and second connector portions together.
